(19) United States
(12) Patent Application Publication
(10) Pub. No.: US 2010/0101882 A1
(43) Pub. Date: Apr. 29, 2010

(54) Portable Powered Mobility Device with Removable Cushions To Improve Foldability

(76) Inventor: Scott R. Thompson, Dickinson, ND (US)

Correspondence Address: REALTRONICS CORPORATION;SCOTT R. THOMPSON, P.O. BOX 906, DICKINSON, ND, 58639, US

(21) Appl. No.: 12/607,990

(22) Filed: Oct. 28, 2009

Related U.S. Application Data
(60) Provisional application No. 61/108,905, filed on Oct. 28, 2008.

(51) Int. Cl. A61G 5/10; A61G 5/08; A61G 5/04; A61G 5/00

(52) U.S. Cl. 180/89.1; 297/440.1

(57) ABSTRACT

A method and apparatus that provides a means to fold a powered mobility device into a vehicle is disclosed. This invention enables powered mobility devices to fit into the trunk of a vehicle and into other small areas.

### CROSS REFERENCE TO RELATED APPLICATIONS

This application claims the benefit of priority under 35 U.S.C. 119(e) to provisional application No. 61/108,905 filed Oct 28, 2008 and titled “Portable Powered Mobility Device—Method and Apparatus”.

### STATEMENT REGARDING FEDERALLY SPONSORED RESEARCH

None

### FIELD OF THE INVENTION

This invention is intended to help disabled persons and those with limited mobility place personal mobility devices into rear vehicle storage compartments.

### BRIEF SUMMARY OF THE INVENTION

Powered mobility devices have been helping people with limited mobility for several decades. One of the downsides of the devices is the limited capability to fit into passenger vehicles. This created a market for rear-vehicle mounted platforms that hold the chair outside of the vehicle and expose it to the elements. The problem is limiting market participation among sedan and other owners of small passenger vehicles. This invention addresses the issue by teaching a method and apparatus to enable a powered mobility device to fold more compactly so that it can fit into the trunk or other storage area of smaller vehicles. The invention relies a plurality of detachable cushions and pivoting mechanisms that allow the chair to fold into a compact state.

### BRIEF DESCRIPTION OF THE INVENTION

Prior art abundantly teaches foldable wheelchairs and various combinations of sectional powered mobility devices that fit into small storage areas like trunks and hatchback regions of small passenger cars. Prior art also teaches wheel chair and powered mobility devices with removable seats that reduce the size of the stowed state. However, prior art fails to teach an easier and more cost effective means to improve size reduction that relies on simply removing seat cushions to increase folding capacity. Prior art instead teaches complete removal of the seat. The method and apparatus taught herein employs recoverably installable cushions that are removed before the chair is folded, which allows the back-rest to fold to a flat position. Select embodiments benefit further from a removable or foldable arm rests of prior art that provide a further reduction in overall height. The principal differentiation of this invention over prior art is the use of quick-detachable seat cushion components.

### DESCRIPTION OF THE DRAWINGS

The accompanying drawings illustrate an embodiment that encompasses the scope of the invention. These drawings are illustrative and are not intended to limit the spirit or scope of this invention, which is to provide a means to fold a powered mobility device into a state that minimizes its height. The full scope of the invention is best understood by studying the drawings.

FIG. 1 is an embodiment of the present invention in an assembled state.

FIG. 2 is an embodiment of the present invention with the bottom cushion removed.

FIG. 3 is an embodiment of the present invention in a folded state.

FIG. 4 shows an embodiment of the present invention that uses slip-connectors to detachably fasten the cushion to the base of the chair.

FIG. 5 shows an embodiment of the present invention in a folded state and with a recoverably installed D-ring coupler attached via an eye-bolt to the chair base.

FIG. 6 shows an embodiment of the present invention in a folded state and with a recoverably installed eye-bolt lift couple affixed to the chair base.

FIG. 7 shows an embodiment of the present invention in a folded state and with a recoverably installed cable lift couple affixed to the chair base.

FIG. 8 shows how an embodiment of the present is able to fit into the trunk of a sedan style passenger car.

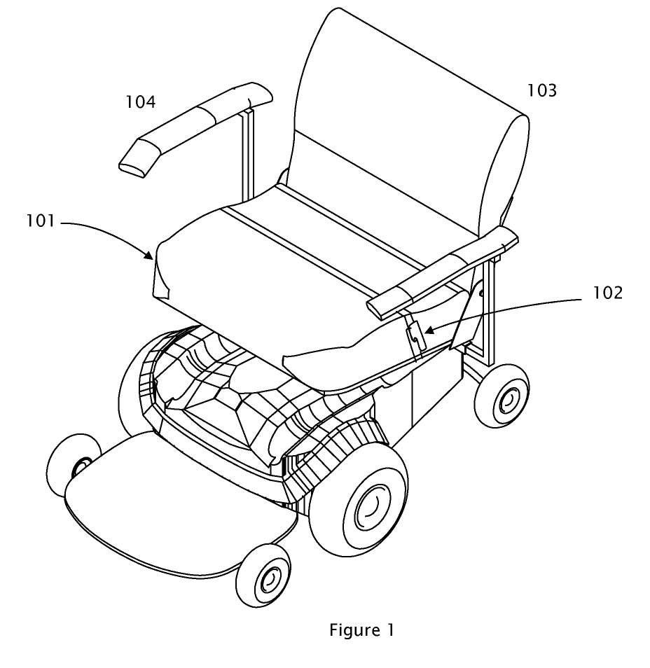

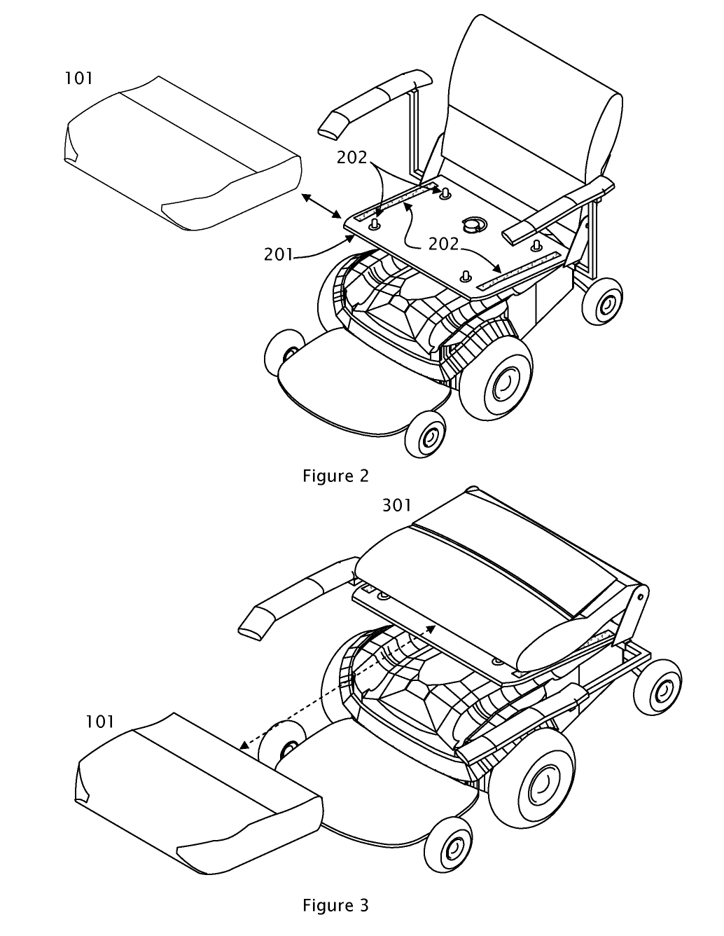

### DETAILED DESCRIPTION OF THE INVENTION

The present invention teaches a means to allow powered mobility devices, also known as powered mobility chairs, to fold into a compact state that is small enough to fit in the storage compartment of most passenger vehicles. This is particularly well suited for sedan style vehicles with rear trunks. The principal components of the device include a removable seat cushion 101, a base 201 adapted to support said cushion, and optionally a detachable backrest 103.

### PREFERRED EMBODIMENTS

All embodiments have a base 201 that is capable of supporting and balancing the intended load of the removable cushion 101. To assist in the latter, preferred embodiments rely on a base 201 that has approximately the same dimensions as the bottom of the seat cushion 101 that is designed for the powered mobility device. In some embodiments the seat is detachably coupled to the base using Velcro 202. This enables quick and easy removal by simply pulling on the seat cushion. Other mechanical means including snap-clips 102, wing nuts, and channel slots 401 and fastening elements 402 will work with other embodiments this invention. Alignment pins 203 or channel slots 401 and fastening elements 402 are recommended to prevent the seat cushion from slipping when in use. Other means to prevent slippage of the cushion 101 relative to the base 201 are possible without deviating from this invention.

Select embodiments of this invention use a detachable rear back rest. These embodiments are well suited for powered mobility devices having large or substantially thick backrest components that do not clear the physical limitations of a trunk when the seat is folded. Installation of quick-release pins, wing-nuts, tabbed pins, hooks, clamps, and the like may be used to make it easier to remove and replace the seat back-rest. Preferred embodiments rely on various combinations of threaded screws and channel slots 401 and fastening elements 402 to make the backrest easy to remove while providing sufficient strength to hold it in position during use.

In some embodiments a coupling device 501 is optimally affixed to the center of mass of the powered mobility device. Recoverably installable methods are preferred for existing chairs that are retro-fitted with this invention. Exemplary coupling device embodiments include eye-hooks 601, cables 701, pipe-inserts with through-holes, flat stock with through holes, and d-rings 501 installed directly to the chair. Other embodiments may be used to couple the chair to a lifting device without deviating from this invention.

### PREFERRED METHODS

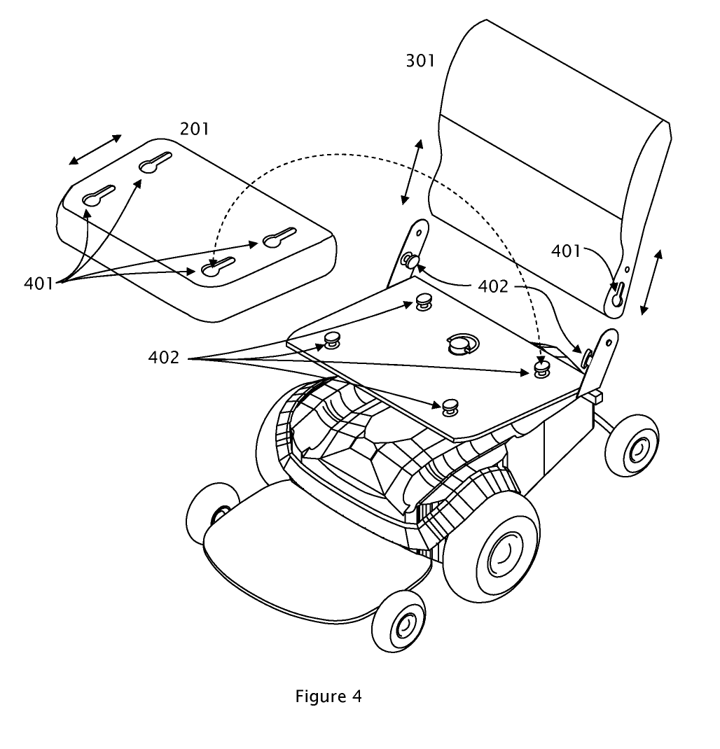

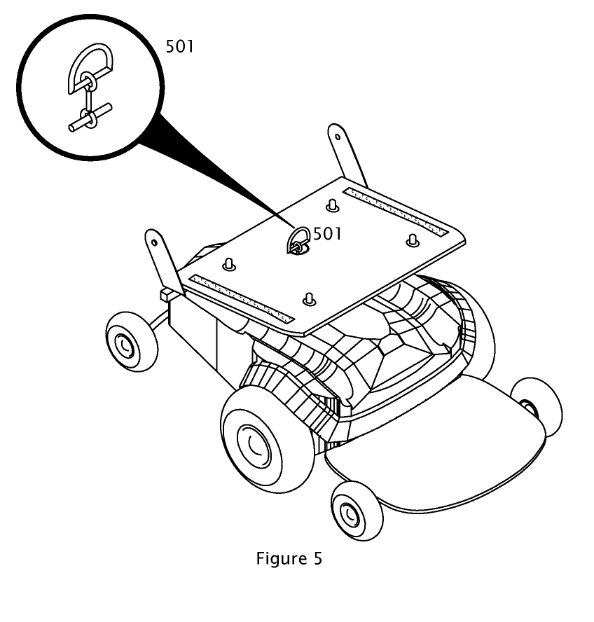

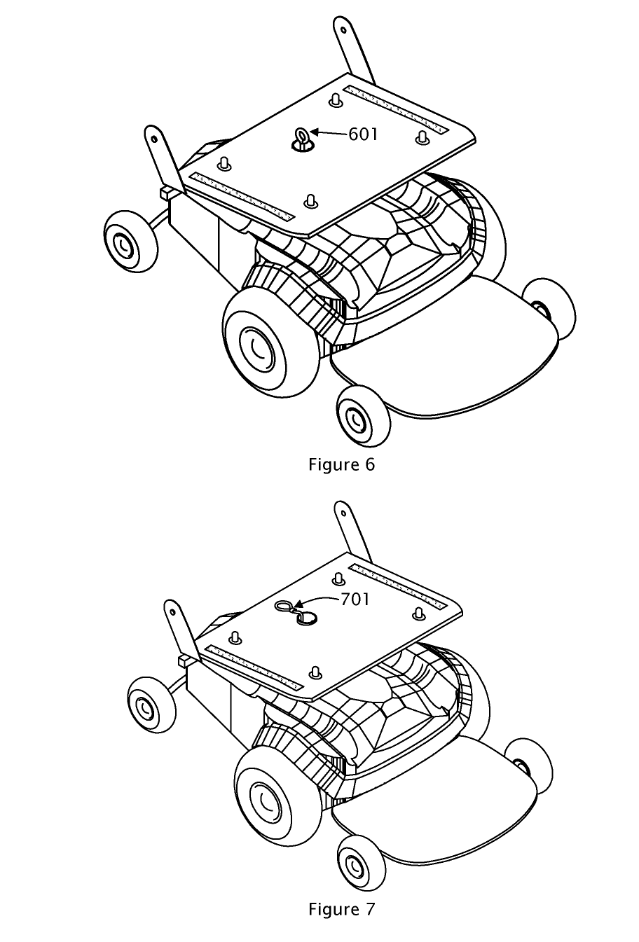

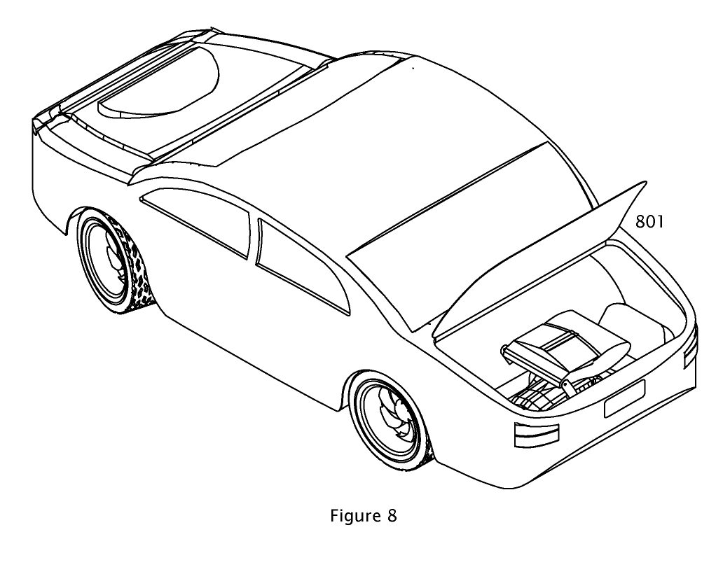

The bottom cushion 201 of the chair is preferably removed as a first step to begin stowage. The rear-back rest 103 is subsequently folded or optionally removed and the arm rests 104 are adjusted downward or removed. For some vehicles, the chair may be lifted, set in the trunk 801 or other storage area, and subsequently folded into a stowed state as illustrated in FIG. 3. Removal of the back-rest 103 may be necessary as the chair is hoisted, particularly if the back-rest interferes with placement of the hoist into the host vehicle.

What is claimed is:

1. A powered mobility device having a chair that folds into a compact state and that comprises in combination:
a. A removable seat cushion,
b. A base dimensionally and physically structured base to support said removable seat cushion and the maximum intended load thereof,
c. A mechanical means to detachably install and remove said seat cushion from said base.

2. A powered mobility device of claim 1 that further comprises in combination:
a. A mechanical means to couple a lifting device to said base of said removable seat cushion.

3. A powered mobility device of claim 1 that further comprises a plurality of alignment pins to prevent movement of said cushion relative to said base adapter.

4. A powered mobility device having a chair that folds into a compact state and that comprises in combination:
a. A removable backrest,
b. A mechanical means to detachably install and remove said backrest from said powered mobility device.

5. A powered mobility device of claim 3 that further comprises plurality of channel slot and fastening elements to detachably install and remove said back rest of said powered mobility device.

6. A method to fold a powered mobility device into a highly compact state that comprises in combination:
a. removing the base seat cushion of said powered mobility device,
b. folding the backrest component forward.

7. A method of claim 6 to fold a powered mobility device into a highly compact state that further comprises removing the backrest of said powered mobility device.
